(19) United States
(12) Patent Application Publication
(10) Pub. No.: US 2002/0138552 A1
(43) Pub. Date: Sep. 26, 2002

(54) Method and system for optimizing private network file transfers in a public peer-to-peer network

(76) Inventors: Timothy S. DeBruine, Santa Clara, CA (US); Nicholas J. Hengeveld IV, San Carlos, CA (US)

Correspondence Address: SAWYER LAW GROUP LLP, P.O. Box 51418, Palo Alto, CA, 94303, US

(21) Appl. No.: 09/814,426

(22) Filed: Mar. 21, 2001

(51) Int. Cl. G06F 15/16

(52) U.S. Cl. 709/203

(57) ABSTRACT

A method and system for optimizing private network file transfers in a public peer-to-peer network. The network includes a plurality of nodes wherein at least two of the nodes are part of the private network. The method and system include receiving a search request from a first node for a file, and in response, determining that the file is stored on a second node. It is then determined whether the first and second nodes are part of the same private network, and if so, the second node is used to transfer the file to the first node over the private network, instead of the public network.

### FIELD OF THE INVENTION

The present invention relates to peer-to-peer networks, and more particularly to a method and system for optimizing private network file transfers in a public peer-to-peer network.

### BACKGROUND OF THE INVENTION

The Internet may be viewed as containing distributed information and centralized information. The distributed information is located throughout the Internet and typically takes the form of domain name servers and IP addresses, for instance. The centralized information is content, such as web pages and files, which is stored on and served by central servers.

Gaining access to such centralized content, however, is becoming increasingly difficult due to growing Internet congestion, limited bandwidth, and increasing file sizes (especially for media rich content). Traditional Internet technologies for distributing content, such as e-mail, streaming media, and FTP, have proven inadequate. E-mail is inadequate because due to the number of email messages and attachments passing through email servers, restrictions are placed on the sizes of emails that restricts what can be sent as attachments. E-mail also has security issues. PGP encryption is available for securing e-mails, but is not widely adopted.

Streaming media has the disadvantages of not working with all file types and is expensive because providers must purchase different software for the various streaming media standards. Streaming media also has not proven to be a reliable transfer method. And FTP file transfers also has disadvantages, which include being technically challenging to most users, causing configuration problems with firewalls, and suffering from inefficient file transfers. There are other solutions for distributing content, but they are usually proprietary and do not scale well.

Another problem with distributing centralized content is cost. As file sizes increase, the distribution of content is becoming increasingly expensive for content providers due to metered pricing of used bandwidth. In metered pricing, a content provider's Internet-Service-Provider (ISP) monitors the output of the servers used to provide the content, and charges the content provider 95% of the peak usage even though the average output is much lower. Thus, the cost of distributing content from central servers is one reason why attempts have been made to decentralize content.

One way to decentralize content is through peer-to-peer networks. Peer-to peer network computing is a more efficient means for distributing resources and content over the Internet. In a peer-to-peer network, all workstations and computers the network may act as servers to all other users on the network. Some peer applications gain efficiencies by aggregating the distributed storage capacity of the computers across the network, such as Napster™ and Gnutella™, or aggregating the idle computing cycles of the computers, such as SETI@home™. Still others, such as instant messaging, take advantage of the direct network connections that peer devices can make to enhance communications.

Although peer networks are effective, current peer networks have inefficiencies. For example, it is not uncommon for a peer-to-peer network to have peers that are part of a private network, such as a local area network (LAN), for instance. When a peer requests a file from another peer, the file transfer typically occurs over the Internet, even when the two peers are within the same private network. In a peer-to-peer network that includes many private networks and many file transfers occurring within the same private network, transferring the file over the Internet is costly and wastes limited bandwidth.

Accordingly, what is needed is a an improved method and system for transferring files in a public peer-to-peer network when file transfers occur between computers belonging to a common private network. The present invention addresses such a need.

### SUMMARY OF THE INVENTION

The present invention provides a method and system for optimizing private network file transfers in a public peer-to-peer network. The network includes a plurality of nodes wherein at least two of the nodes are part of the private network. The method and system include receiving a search request from a first node for a file, and in response, determining that the file is stored on a second node. It is then determined whether the first and second nodes are part of the same private network, and if so, the second node is used to transfer the file to the first node over the private network, instead of the public network.

Accordingly, the present invention prevention spares network bandwidth minimizing the need to transfer the file over the Internet when a node is available to transfer the file that belongs to the same private network as the requesting node.

### BRIEF DESCRIPTION OF THE DRAWINGS

FIGS. 1A and 1B are block diagrams illustrating a peer-to-peer (P2P) network architecture.

FIG. 2 is a flow chart illustrating the process for registering a client node with the server node.

FIG. 3 is a block diagram illustrating a preferred embodiment of the client application desktop window.

FIGS. 4A and 4B are flow charts illustrating the process of deciding whether a client node is locally reachable from the same private network as a requesting client node.

### DETAILED DESCRIPTION

The present invention relates to facilitating file access on peer-to-peer networks. The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiments shown but is to be accorded the widest scope consistent with the principles and features described herein.

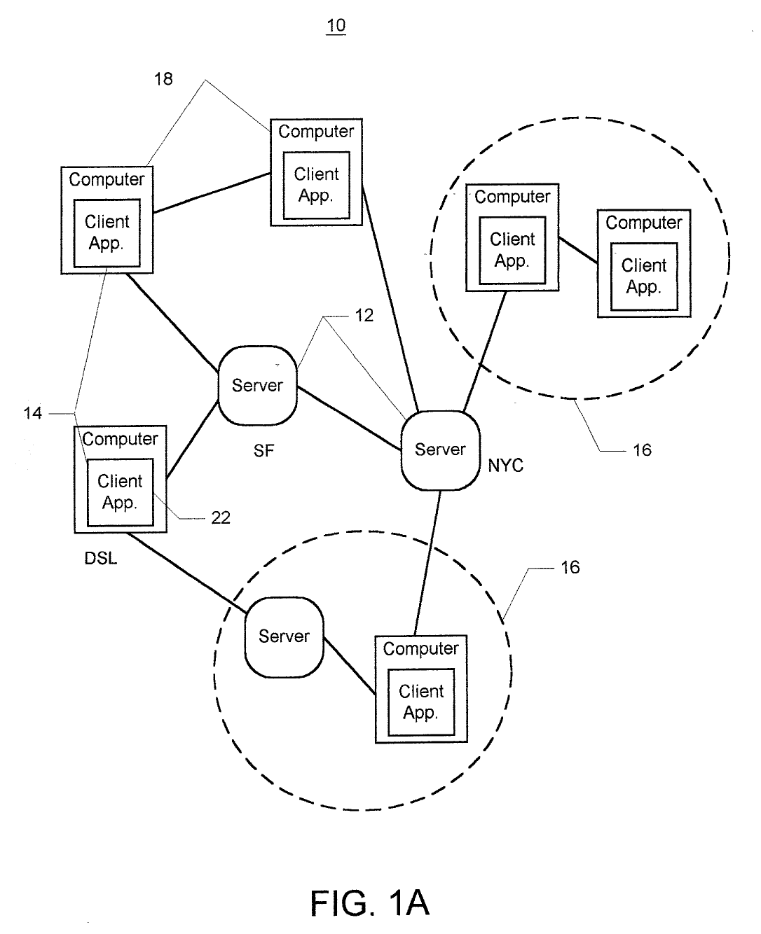

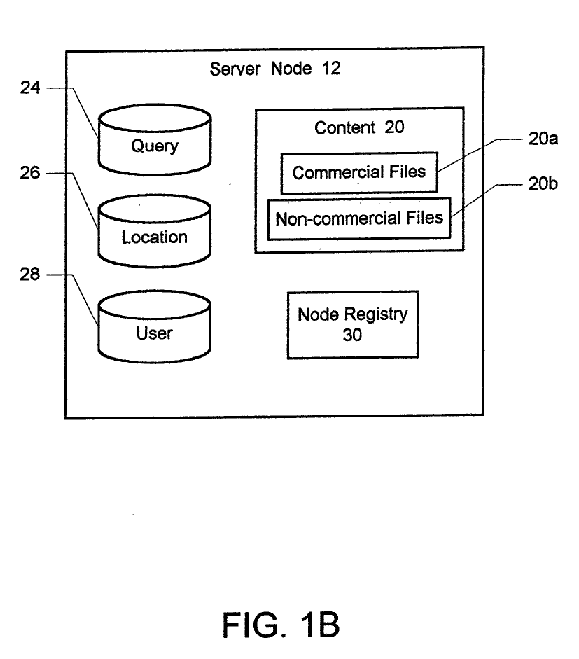

FIGS. 1A and 1B are block diagrams illustrating a peer-to-peer (P2P) network architecture for use in accordance with one preferred embodiment of the present invention. The peer-to-peer network 10 includes a plurality of computers 18 interconnected over a network, such as Internet, where some of the computers 18 are configured as server nodes 12, and other computers 18 are configured as client 20 nodes 14. A client node 14 may represent a single computer or a proprietary network, such as AOL, or a cable network, for example, and in a preferred embodiment, the server nodes 14 are located worldwide.

Any combination of server nodes 12 and client nodes 14 may form a private network 16, such as a local area network (LAN) or an extranet, which is a private network that uses the public Internet as its transmission system, but requires passwords to gain entrance. Some of the private networks 16 may be protected by a firewall 17. Firewalls 17 are widely used to give users of a private network 16 access to the Internet in a secure fashion as well as to separate a company's public web server from its internal network.

FIG. 1B is a diagram illustrating contents of the server nodes 12 in a preferred embodiment of the present invention. Each server node 12 includes several databases for implementing the functions described above. The server node 12 includes a query database 24, a location database 26, a user database 28. The query and a location databases 24 and 26 store the names and locations of the files shared on the network, respectively. And the user database 32 includes account information for the users of the client nodes 14. In accordance with the present invention, the server node 12 also includes a node registry 30 for registering each node that is logged into the network 10.

The primary purpose of the peer-to-peer network 10 is the propagation of content files over the network 10. In a preferred embodiment, each server node 12 stores content 20 that comprises both commercial files 20a and noncommercial files 20b. Example type of content files may include audio MP3 files, video files, news articles and online magazines, image files, and confidential documents, for instance. Once the content files have been downloaded from the server 12 to client nodes 14, the client nodes 14 serve the files directly to other client nodes 14. Thus, a need exist in the peer-to-peer network to allow each node 14 in the network 10 to share files with other nodes 14 in the network, regardless of whether two nodes 14 are separated by a firewall 17.

The present invention provides a method and system for optimizing private network file transfers in a public peer-to-peer network, such that nodes that are part of the same private network 16 share files by transferring the files within the private network 16, rather than transferring the files over the public network 10 (via the Internet). This is accomplished by recognizing when two nodes that need to transfer a file belong to the same private network, and causing the two nodes to send their request/responses to each other through their private network, rather than going through the Internet.

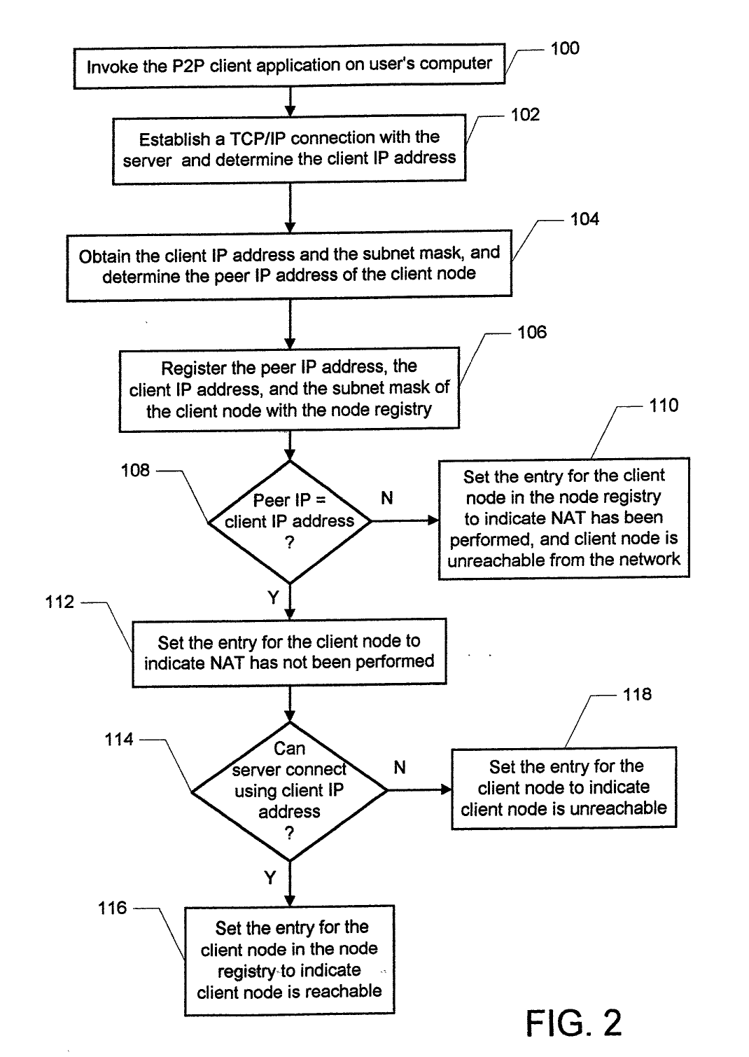

FIGS. 2-4 illustrate the process of optimizing private network file transfers in a public peer-to-peer network in accordance with a preferred embodiment of the present invention.

The optimization process begins with the registration of client nodes 14 with the server node 12, as illustrated in the flow chart of FIG. 2. Once a user invokes the P2P client application 22 on their computer 18 in step 100, a TCP/IP connection is established with the server 12, and the client node determines its client IP in step 102. As is well known in the art, an IP (Internet Protocol) address is the address of a computer attached to a TCP/IP network. Every computer and server is assigned a unique IP address. Computers 18 have either a permanent address or one that is dynamically assigned to them each dial-up session.

During the TCP/IP connection, two interconnected nodes exchange requests/responses in the form of TCP/IP packets. Each TCP/IP packet sent out from the client node identifies the client node 14 and contains application data, the client IP address of the client node 14, and a destination IP address of the recipient. IP addresses are written as four sets of numbers separated by periods; for example, 204.171.64.2, that includes a network address (netid) that identifies the private network or subnet, and a host address (hostid) that identifies the computer within the private network. The subnet mask is a method used for splitting IP networks into a series of subgroups, or subnets. The mask is a binary pattern that is matched up with the IP address to turn part of the host ID address field into a field for subnets. Computers 18 can determine their subnet mask by making an operating system call.

When a client node 14 is part of a private network, the private network may or may not be protected by a firewall, and the firewall may or may not perform network address translation (NAT). NAT is a process whereby a firewall translates a range of IP addresses to another as packets are routed between networks. NAT also keeps individual addresses of the private network hidden from the outside world.

After the client node 14 establishes a TCP/IP connection, the server 12 obtains the client IP address and the subnet mask from the TCP/IP packet, and determines the peer IP address of the client node 14 by sending a probe message to the client node 14 and observing what IP address the client node 14 is connecting from in step 104. Thereafter, a registration process is initiated whereby the client node 14's peer IP address, client IP address, and subnet mask node are registered in the node registry 30 in step 106.

The node registry 30 then determines if the client node 14 is protected by a firewall by comparing the observed peer IP address with the reported client IP address in step 108. If the peer IP address does match the client IP address, then the entry for the client node 14 in the node registry 30 is set to indicate that both NAT has been performed on the client node 14, and that the client node 14 is unreachable from the network 10 in step 110.

If the peer IP address matches the client IP address, then the entry for the client node 14 is set to indicate that NAT has not been performed on the client node 14 in step 112. If the server can connect to the client node 14 through the client IP address in step 114, then the entry for the client node 14 in the node registry 30 is set to indicate that the client node 14 is directly reachable from the network 10 in step 116. If the server node 12 cannot connect to the client node 14, then the node registry is set to indicate that the node is unreachable from the network 10 in step 118.

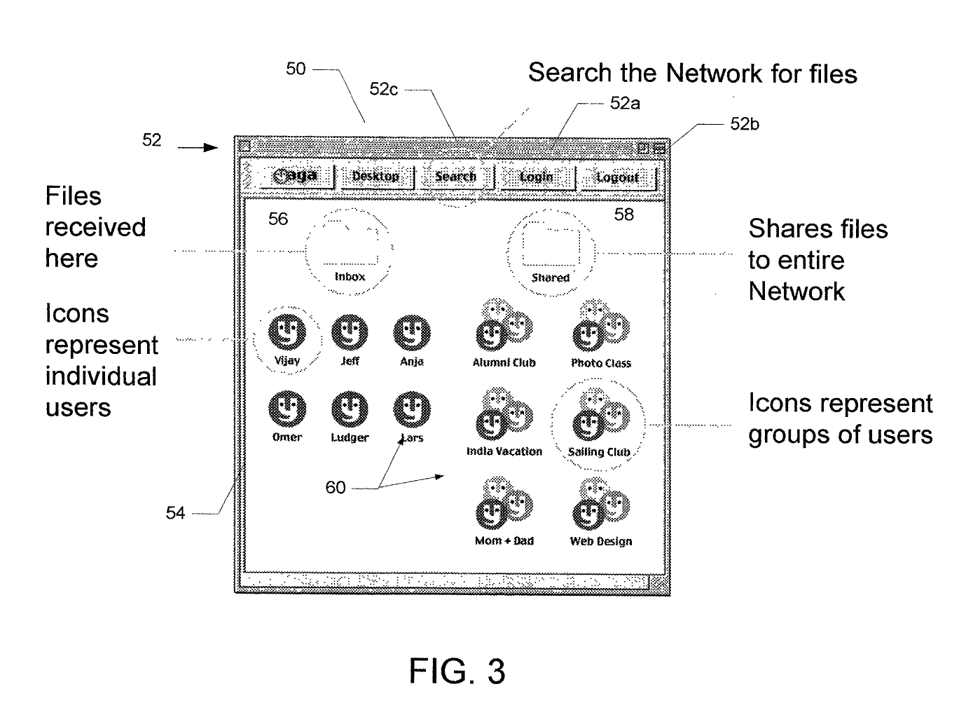

Besides registering with the node registry 30, the client application 22 also displays a client application desktop window on the computer to allow the user to share files on the network 10. Referring now to FIG. 3, a block diagram is shown illustrating a preferred embodiment of the client application desktop window. The client application 22 allows the user to perform three primary functions: publish over the network, receive files over the network, and search for files to download. The client application desktop window 50 may include a row of command buttons 52, and an area 54 for displaying folders and icons. The user logs in and out of the network 10 via command buttons 52a and 52b, and may search for files on the network via the search button 52c. An inbox folder to 56 contains files that are received over the network 10, and a shared folder 58 contains files that the user wishes to publish over the network 10 for access by other client nodes 14. User icons 60 represent individual users and groups of users to which the user wants to exchange files with on a peer-to-peer basis.

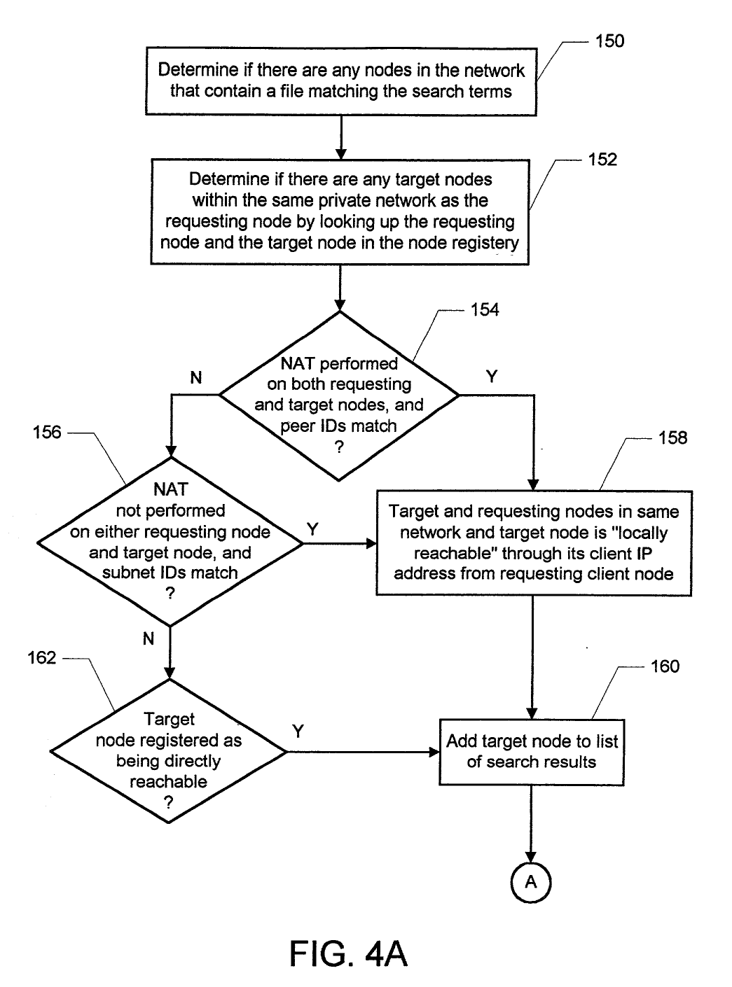

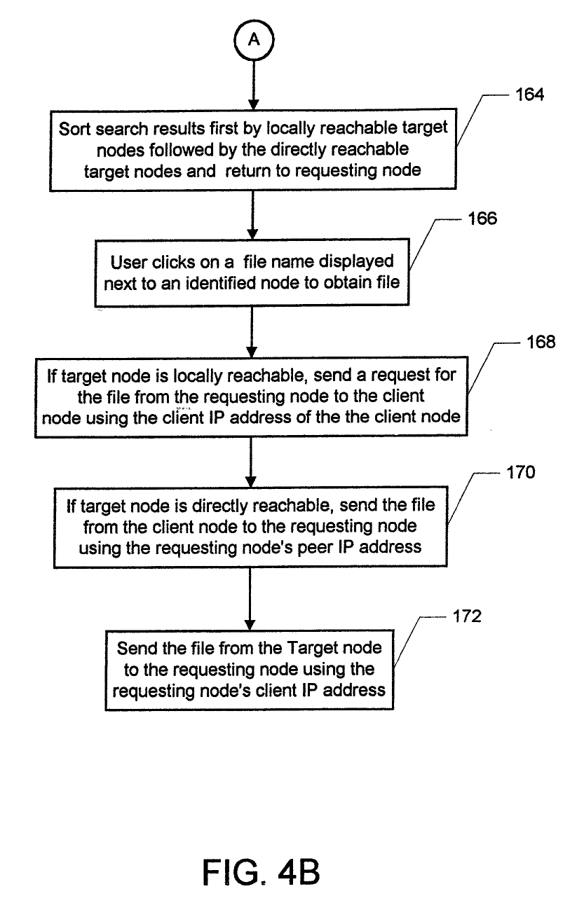

FIGS. 4A and 4B are flow charts illustrating the process of deciding whether a client node is locally reachable from the same private network as a requesting client node in response to the user clicking on the search button 52c and entering search terms. Once the server node 12 receives the search terms, it is determined if there are any nodes in the network that contain a file matching the search terms in step 150. This is accomplished by searching the query database 24 for file names that match the search terms and by then finding the nodes containing that file by querying the location database 26. The client nodes 14 containing the file will hereinafter be referred to as target nodes.

According to the present invention, instead of just displaying a list of matching file names on all nodes throughout the network 10, the server node 12 further determines whether there are any target nodes within the same private network as the requesting node by looking up the requesting node and the target node in the node registry 30 in step 152. If the node registry 30 indicates that NAT has been performed on both nodes and at the peer IDs of both nodes match in step 154, then the target node is considered to be within the same network as the requesting client node and therefore “locally reachable” through its local client IP address from the requesting client node in step 158.

If the condition of step 152 fails, but the node registry 30 indicates that NAT has not been performed on either of the client nodes 14 and that the subnet IDs of each of the client nodes 14 match in step 156, then the target node is still considered to be within the same network as the requesting client node and locally reachable from the requesting client node in step 158. If the target node is found to be locally reachable, then it is added to the search results list that will be returned to the requesting client node in step 160.

If the target node is not locally reachable (not within the same private network as the requesting node), then it is determined whether the requesting node can communicate directly with the target node by looking up the requesting and target nodes in the node registry 30 to determine if it is registered as being directly reachable through its peer ID in step 162. If the target node is directly reachable, the target node is added to the list of search results in step 164. If none of the conditions above are not met, then it is determined that the client node 14 containing file is not reachable from the requesting node.

Referring now to FIG. 4B, after all the target nodes are examined, the search results are sorted first by locally reachable client nodes 14 followed by the directly reachable client nodes 14 and then returned to the requesting node in step 164. In a preferred embodiment, the name of the file, and the identities and addresses of the client node(s) 14 are included in the search result sent to the requesting node.

After the search results are received on the requesting node, the user may click on the file name displayed next to an identified node to obtain the file in step 166. If the target node is locally reachable, then the client application 22 sends the request for the file to the target node using the client IP address of the target node in step 168. If the target node is directly reachable, then the client application sends the request for the file to the target node using the peer IP address in step 170. The target node 14 then responds by sending the file to the requesting node using the requesting node's client IP address in step 172.

Thus, when the target node is within the same private network as the requesting node (locally reachable), the present invention enables the two nodes to communicate such that the file is transferred over the private network.

In an alternative embodiment, the server node 12 may return a list of search results to the requesting node, where the list includes the identities and addresses of the matching nodes, their IP addresses and subnet masks, port, reachability status and so on, to the requesting node. The requesting node may then perform the comparisons described above to determine if any of the nodes are on the same private network.

According to the present invention, file transfers on the P2P network 10 are optimized by identifying when a node requesting a file is on the same private network as a second node containing the file, and using the second node to transfer the file using over the private network. By not sending the file from another node that is not part of the private network, an Internet file transfer does not take place, sparing network bandwidth.

A method and system for optimizing private network file transfers in a public peer-to-peer network has been disclosed. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for optimizing private network file transfers in a peer-to-peer public network, the peer-to-peer public network including a plurality of nodes, wherein at least two of the node are part of a same private network, the method comprising the steps of:
(a) receiving a search request from a first node for a file;
(b) determining that the file is stored on a second node;
(c) determining that the first and second nodes are part of the same private network; and
(d) using the second node to transfer the file to the first node over the private network instead of the public network.

2. The method of claim 1 further wherein step (a) includes the step of registering a client IP address, a subnet mask, and a peer IP address of both the first and second nodes with a server.

3. The method of claim 2 wherein step (a) further includes the step of registering with the server whether network address translation (NAT) has been performed on the first and second nodes and whether the first and second nodes are directly reachable from other nodes on the public network or unreachable.

4. The method of claim 3 wherein step (a) further includes the step of determining that NAT has been performed on a particular node when the node's client IP address does not match the node's peer IP address.

5. The method of claim 4 wherein step (a) further includes the step of determining that a particular node is directly reachable from other nodes on the public network when the server can connect with the node using the node's client IP address.

6. The method of claim 2 wherein step (a) further includes the step of storing the client IP address, a subnet mask, and a peer IP address of both the first and second nodes in a node registry.

7. The method of claim 1 wherein step (a) further includes the step of allowing a user of the first node to enter search terms for finding a particular file.

8. The method of claim 7 wherein step (b) further includes the steps of querying a database containing file names with the search terms to find file names matching the search terms, and by identifying nodes containing the matching file, including the second node.

9. The method of claim 4 wherein step (c) further includes the steps of:
(i) determining that the second node is part of the same private network as the first node, and therefore locally reachable by the first node, when
(1) NAT has been performed on both the first and second nodes and at the peer IDs of both the first and second nodes match, or
(2) NAT has not been performed on either the first and second nodes and the subnet IDs of each first and second nodes match.

10. The method of claim 9 wherein step (c) further includes the steps of:
(ii) returning a list of search results from the server to the first node, where the list includes the identities and addresses of the matching nodes, IP addresses, and subnet masks.

11. The method of claim 10 wherein step (c)(ii) further includes the step of sorting the search results first by locally reachable nodes followed by the directly reachable nodes.

12. The method of claim 10 wherein step (d) further includes the steps of:
(i) using the client IP address of the second node to send a request for the file from the first node to the second node; and
(ii) sending the file from the second node to the first node using the client IP address of the first node.

13. A peer-to-peer public network, comprising
at least one server coupled to the public network;
a first plurality of nodes coupled to the public network;
a private network including first and second nodes coupled to the public network, wherein when the server receives a search request from the first node for a file, the server
determines that the file is stored on the second node,
determines that the first and second nodes are part of the same private network, and
instructs the first node to request the file from the second node, such that the file is transferred from the second node to the first node over the private network instead of the public network.

14. The network of claim 13 wherein a client IP address, a subnet mask, and a peer IP address of both the first and second nodes are registered with the server.

15. The public network of claim 14 wherein the server registers whether network address translation (NAT) has been performed on the first and second nodes and whether the first and second nodes are directly reachable from other nodes on the public network or unreachable.

16. The public network of claim 15 wherein it is determined that NAT has been performed on a particular node when the node's client IP address does not match the node's peer IP address.

17. The public network of claim 16 wherein it is determined that a particular node is directly reachable from other nodes on the public network when the server can connect with the node using the node's client IP address.

18. The public network of claim 17 wherein the client IP address, a subnet mask, and a peer IP address of both the first and second nodes are stored in a node registry.

19. The public network of claim 13 wherein a user of the first node enters search terms for finding a particular file.

20. The public network of claim 18 wherein it is determined the file is stored on the second node by querying a database containing file names with the search terms to find file names matching the search terms, and by identifying nodes containing the matching file, including the second node.

21. The public network of claim 16 wherein it is determined that the second node is part of the same private network as the first node, and therefore locally reachable by the first node, when 1) NAT has been performed on both the first and second nodes and at the peer IDs of both the first and second nodes match, or 2) NAT has not been performed on either the first and second nodes and the subnet IDs of each first and second nodes match.

22. The public network of claim 21 wherein the server returns a list of search results is returned to the first node, where the list includes the identities and addresses of the matching nodes, IP addresses, and subnet masks.

23. The public network of claim 22 wherein the search results are sorted first by locally reachable nodes followed by the directly reachable nodes.

24. The public network of claim 22 wherein the client IP address of the second node is used to send a request for the file from the first node to the second node, and the file from the second node is sent to the first node using the client IP address of the first node.

25. A computer readable medium containing program instructions for optimizing private network file transfers in a peer-to-peer public network, the peer-to-peer public network including a plurality of nodes, wherein at least two of the node are part of a same private network, the program instructions for:
(a) receiving a search request from a first node for a file;
(b) determining that the file is stored on a second node;
(c) determining that the first and second nodes are part of the same private network; and
(d) using the second node to transfer the file to the first node over the private network instead of the public network.

26. The computer readable medium of claim 25 further wherein instruction (a) includes the instruction of registering a client IP address, a subnet mask, and a peer IP address of both the first and second nodes with a server.

27. The computer readable medium of claim 26 wherein instruction (a) further includes the instruction of registering with the server whether network address translation (NAT) has been performed on the first and second nodes and whether the first and second nodes are directly reachable from other nodes on the public network or unreachable.

28. The computer readable medium of claim 27 wherein instruction (a) further includes the instruction of determining that NAT has been performed on a particular node when the node's client IP address does not match the node's peer IP address.

29. The computer readable medium of claim 28 wherein instruction (a) further includes the instruction of determining that a particular node is directly reachable from other nodes on the public network when the server can connect with the node using the node's client IP address.

30. The computer readable medium of claim 26 wherein instruction (a) further includes the instruction of storing the client IP address, a subnet mask, and a peer IP address of both the first and second nodes in a node registry.

31. The computer readable medium of claim 25 wherein instruction (a) further includes the instruction of allowing a user of the first node to enter search terms for finding a particular file.

32. The computer readable medium of claim 30 wherein instruction (b) further includes the instructions of querying a database containing file names with the search terms to find file names matching the search terms, and by identifying nodes containing the matching file, including the second node.

33. The computer readable medium of claim 28 wherein instruction (c) further includes the instructions of:
(i) determining that the second node is part of the same private network as the first node, and therefore locally reachable by the first node, when
(1) NAT has been performed on both the first and second nodes and at the peer IDs of both the first and second nodes match, or
(2) NAT has not been performed on either the first and second nodes and the subnet IDs of each first and second nodes match.

34. The computer readable medium of claim 33 wherein instruction (c) further includes the instructions of:
(ii) returning a list of search results from the server to the first node, where the list includes the identities and addresses of the matching nodes, IP addresses, and subnet masks.

35. The computer readable medium of claim 34 wherein instruction (c)(ii) further includes the instruction of sorting the search results first by locally reachable nodes followed by the directly reachable nodes.

36. The computer readable medium of claim 34 wherein instruction (d) further includes the instructions of:
(i) using the client IP address of the second node to send a request for the file from the first node to the second node; and
(ii) sending the file from the second node to the first node using the client IP address of the first node.

37. A method for optimizing private network file transfers in a peer-to-peer public network, the peer-to-peer public network including a plurality of nodes, wherein a first node and a second node are part of a same private network, the method comprising the steps of:
(a) registering with the server whether network address translation (NAT) has been performed on the first and second nodes and whether the first and second nodes are directly reachable from other nodes on the public network;
(b) receiving a search request from the first node for a file;
(c) determining that the file is stored on the second node;
(d) determining that the second node is part of the same private network as the first node, and therefore locally reachable by the first node, when
(i) NAT has been performed on both the first and second nodes and at the peer IDs of both the first and second nodes match, or
(ii) NAT has not been performed on either the first and second nodes and the subnet IDs of each first and second nodes match.
(e) using the second node to transfer the file to the first node over the private network instead of the public network.

38. The method of claim 37 further wherein step (a) includes the step of registering a client IP address, a subnet mask, and a peer IP address of both the first and second nodes with a server.

39. The method of claim 38 wherein step (a) further includes the step of determining that NAT has been performed on a particular node when the node's client IP address does not match the node's peer IP address.

40. The method of claim 39 wherein step (a) further includes the step of determining that a particular node is directly reachable from other nodes on the public network when the server can connect with the node using the node's client IP address.

41. The method of claim 40 wherein step (d) further includes the step of returning a list of search results from the server to the first node, where the list includes the identities and addresses of the matching nodes, IP addresses, and subnet masks.

42. The method of claim 41 wherein step (d) further includes the step of sorting the search results first by locally reachable nodes followed by the directly reachable nodes.

43. The method of claim 42 wherein step (e) further includes the steps of:
(i) using the client IP address of the second node to send a request for the file from the first node to the second node; and
(ii) sending the file from the second node to the first node using the client IP address of the first node.
